(19) United States
(12) Patent Application Publication
(10) Pub. No.: US 2026/0322814 A1
(43) Pub. Date: Oct. 15, 2026

(54) AUTHENTICATION METHOD AND APPARATUS, AND READABLE STORAGE MEDIUM, AND ELECTRONIC DEVICE

(71) Applicant: Alipay (Hangzhou) Digital Service Technology Co., Ltd., Hangzhou (CN)

(72) Inventor: Rui ZHANG, Hangzhou (CN)

(21) Appl. No.: 19/707,049

(22) Filed: Jun. 12, 2026

Related U.S. Application Data
(63) Continuation of application No. PCT/CN2024/128073, filed on Oct. 29, 2024.

(30) Foreign Application Priority Data
Dec. 13, 2023 (CN) 202311713434.1

(51) Int. Cl. H04L 9/40

(52) U.S. Cl. CPC H04L 63/0876; H04L 63/10

(57) ABSTRACT

The present specification relates to an authentication method and apparatus, a readable storage medium, and an electronic device. The authentication method is applied to a server, a first aspect program is pre-injected at a first predetermined pointcut of the server, and the authentication method includes: in response to a client accessing the server, receiving an access request that is sent by the client and that is used to access the server, where the access request includes identity information of the client; determining an identity of the client based on the identity information of the client by using the first aspect program, determining access permission of the client based on the identity of the client, and then obtaining access data based on the access permission of the client; and sending the access data to the client. According to the authentication method and apparatus, the readable storage medium, and the electronic device in the present specification, an authentication function is implemented by using aspect programs pre-injected at predetermined pointcuts of the client and the server, so that the authentication function is decoupled from another function of the server, thereby avoiding interference to the another function, and privacy data leakage can be avoided through authentication.

### CROSS-REFERENCE TO RELATED APPLICATION

The present application is a continuation of PCT Application No. PCT/CN2024/128073, filed on Oct. 29, 2024, which claims priority benefit to Chinese Patent Application No. 202311713434.1, filed on Dec. 13, 2023, which are all incorporated herein by reference in their entirety for all purposes.

### TECHNICAL FIELD

The present specification relates to the field of privacy protection technologies, and more specifically, to an authentication method and apparatus, a readable storage medium, and an electronic device.

### BACKGROUND

With the development of the Internet technologies, a user can implement different functions by using various application clients installed on a terminal device. When implementing functions of the application client, the application client usually needs to exchange information with a server, for example, to access data of the server and invoke an interface of the server.

Because the server stores a large amount of privacy data (for example, in a trusted execution environment), when the client requests data from the server, the server performs identity confirmation on the client, and then returns the requested data to the client, to avoid privacy leakage caused when unauthorized clients invoke privacy data.

However, the those functions are coupled to other functions of the client and the server. When a functions is to be modified, source code of the functions needs to be modified, causing interference to other functions of the client and the server.

### SUMMARY

The present specification provides an authentication method, applied to a server. When a client accesses the server, an authentication function is implemented by using a first aspect program that is pre-injected at a first pointcut of the server, so that the authentication function is decoupled from another function of the server, thereby avoiding interference to the another function.

A first aspect program is pre-injected at a first pointcut of the server, and the authentication method includes: in response to a client accessing the server, receiving an access request that is sent by the client and that is used to access the server, where the access request includes identity information of the client; determining an identity of the client based on the identity information of the client by using the first aspect program, determining access permission of the client based on the identity of the client, and then obtaining access data based on the access permission of the client; and sending the access data to the client.

In some implementations, the determining the identity of the client based on the identity information of the client includes: comparing the identity information of the client with pre-stored standard identity information to determine the identity of the client.

In some implementations, the determining the access permission of the client based on the identity of the client includes: searching a predetermined access permission configuration table for the access permission of the client based on the identity of the client.

In some implementations, the obtaining the access data based on the access permission of the client includes: determining an accessible field of the client based on the access permission of the client; and obtaining all accessible fields of the client as the access data.

The present specification provides an authentication method, applied to a client. An authentication function is implemented by using a second aspect program pre-injected at a second pointcut of the client, so that the authentication function is decoupled from another function of the client, thereby avoiding interference to the another function.

A second aspect program is pre-injected at a second pointcut of the client, and the authentication method includes: in response to the client accessing a server, generating an access request used to access the server; collecting identity information of the client by using the second aspect program, and inserting the identity information of the client into the access request; sending the access request that includes the identity information of the client to the server, for the server to confirm an identity of the client based on the identity information of the client, determines access permission of the client based on the identity of the client, then obtains access data based on the access permission of the client, and sends the access data to the client; and receiving the access data sent by the server.

The present specification provides an authentication apparatus, used in a server. An authentication function is implemented by using a first aspect program pre-injected at a first predetermined pointcut of the server, so that the authentication function is decoupled from another function of the server, thereby avoiding interference to the another function.
_A first aspect program is pre-injected at a first predetermined pointcut of the server, and the authentication apparatus includes: a first receiving module, configured to: in response to a client accessing the server, receive an access request that is sent by the client and that is used to access the server, where the access request includes identity information of the client; a determining module, configured to: determine an identity of the client based on the identity information of the client by using the first aspect program, determine access permission of the client based on the identity of the client, and then obtain access data based on the access permission of the client; and a first sending module, configured to send the access data to the client.

In some implementations, the determining the identity of the client based on the identity information of the client includes: comparing the identity information of the client with pre-stored standard identity information to determine the identity of the client.

In some implementations, the determining the access permission of the client based on the identity of the client includes: searching a predetermined access permission configuration table for the access permission of the client based on the identity of the client.

In some implementations, the obtaining the access data based on the access permission of the client includes: determining an accessible field of the client based on the access permission of the client; and obtaining all accessible fields of the client as the access data.

The present specification provides an authentication apparatus, used in a client. An authentication function is implemented by using a second aspect program pre-injected at a second predetermined pointcut of the client, so that the authentication function is decoupled from another function of the client, thereby avoiding interference to the another function.

A second aspect program is pre-injected at a second predetermined pointcut of the client, and the authentication apparatus includes: a generation module, configured to: in response to the client accessing a server, generate an access request used to access the server; a collection module, configured to: collect identity information of the client by using the second aspect program, and insert the identity information of the client into the access request; a second sending module, configured to send the access request that includes the identity information of the client to the server, for the server to confirm an identity of the client based on the identity information of the client, determines access permission of the client based on the identity of the client, then obtains access data based on the access permission of the client, and sends the access data to the client; and a second receiving module, configured to receive the access data sent by the server.

The present specification provides a readable storage medium on which a computer program is stored. When the computer program is executed in a computer, the computer is caused to implement the above authentication method.

The present specification provides a computing device that includes a storage and a processor. The storage stores executable code, and when the processor executes the executable code, the processor implements the above authentication method.

### BRIEF DESCRIPTION OF DRAWINGS

FIG. 1 is a flowchart illustrating a method according to an implementation of the present specification;

FIG. 2A is a flowchart illustrating an authentication method applied to a server according to an implementation of the present specification;

FIG. 2B is a flowchart illustrating an authentication method applied to a client according to an implementation of the present specification;

FIG. 3 is a structural block diagram illustrating an authentication apparatus used in a server according to an implementation of the present specification; and

FIG. 4 is a structural block diagram illustrating an authentication apparatus used in a client according to an implementation of the present specification.

### DESCRIPTION OF EMBODIMENTS

With reference to the accompanying drawings, the following provides some implementations of the present specification and describes the implementations in detail.

A security aspect refers to a technical solution for dynamically adding or modifying, without modifying an application, an aspect program used to implement a security aspect function in running logic of the application through aspect-oriented programming (AOP). As such, a program that implements the security aspect function is decoupled from the application while implementing the security aspect function, thereby avoiding a development iteration problem caused by high coupling.

The aspect program herein is an enhanced program for implementing the security aspect function based on function running logic. The aspect program can be injected into a corresponding pointcut of the application through AOP, and the aspect program is triggered to be executed during execution of the application, to implement a security aspect function.

When the application performs a function, the application usually performs the function through invocation between processes. Therefore, any process in the application can be used as a cutting point of the aspect program, e.g., the above mentioned pointcut, and the aspect program is injected into a corresponding pointcut. When an application executes to a pointcut, e.g., invokes a process of an application corresponding to the pointcut, an aspect program injected at the pointcut is executed.

Generally, code responsible for a process of injecting the aspect program into the pointcut has high reusability. Therefore, a program implementing the process is generally configured as a service module, e.g., an aspect base. The aspect base can obtain an aspect program that needs to be deployed and obtain a pointcut at which the aspect program is inserted into the application from a server that provides a security aspect function, is woken up after an application container is started, and injects a corresponding aspect program at the pointcut of the application.

The application can be an application that provides a function service on a server of a function platform. The function service can be a function service provided by the server of the function platform to a user, for example, a query function and a payment function. The function service can also be a function service provided by a server of the function platform to another server, for example, a settlement function.

Certainly, it can be learned from the above description that, a security aspect function program is decoupled from an application. In the present specification, the security aspect function program and the application are interleaved during function execution through AOP, but can be independently maintained in parallel with each other. Therefore, different from a function provider of the application, a third party that provides the security aspect function can manage, through a server, content related to the security aspect function, for example, configuration of a security aspect function management and control policy, version iteration of the aspect program, and deployment rule configuration of the aspect program. Certainly, the security aspect function can be provided by a third party or a function provider.

When managing the content related to the security aspect function, the server can record various configuration information such as configuration of various policies and deployment rule configurations of the aspect program by using a configuration file. The aspect base can deploy the aspect program based on the configuration file, or the server can implement the security aspect function based on the configuration file.

In practice, the function provider is usually provided with an equipment room that includes several physical machines or physical servers, and provides, by using the physical machines, physical resources required by the application. Certainly, an application possibly may not need all physical resources of an entire physical machine. Therefore, generally, a plurality of virtual hosts are running on one physical machine by using a virtualization technology. All the virtual hosts are independent of each other, and each virtual host enjoys a part of physical resources of the physical machine. An application container can then be deployed in the virtual host, and the application can be run by using the application container. The application container usually includes a physical resource allocated to the application container, such as a CPU or memory, and a running environment provided for the application container, such as an operating system (OS) or other running environment data, for example, a container serial number (SN), an allocated influential property (IP), an application name, a tenant, and an environment variable. The application can be deployed in an application container to perform functions.

In a scenario in which a function is executed based on a security aspect, a server can be provided as a server of a function provider or a server of a third party that provides a security aspect function, the server manages content related to the security aspect function, and deploys an aspect base in an application container, and the aspect base injects an aspect program into an application in the application container, to provide security aspect function support for the application container of the function provider.

Therefore, the aspect base can be pre-deployed in the application container of the function provider. In some implementations, when the application container is started, an operating system provided for the application container can be evoked, and the pre-deployed aspect base is run. The aspect base obtains the aspect program and a pointcut of the application from the server, and injects the aspect program at the pointcut of the application in the application container. In addition, the aspect base can also obtain the aspect program and the pointcut of the application from the server in an application execution process, and inject the aspect program at the pointcut of the application in the application container.

Certainly, how the aspect base obtains, from the server, information required for deploying the aspect program can be set based on a requirement. For example, the aspect base can actively pull required information from the server based on a configuration file, or the server can actively perform information delivery, so that the aspect base receives required information.

After the aspect program is injected into a pointcut of an application, the application can trigger the aspect program in an execution process, to implement a corresponding security aspect function.

When implementing various functions of a client of an application installed on a terminal device, the client exchanges information with a server, for example, access data of the server and invoke an interface of the server. Because the server stores a large amount of sensitive privacy data, when the client requests data from the server, the server first performs identity confirmation on the client, and then returns the requested data to the client, to avoid privacy leakage caused when unauthorized clients invoke privacy data. An existing identity confirmation function is coupled to other functions of the client and the server. When the identity confirmation function needs to be modified, source code needs to be modified, causing interference to the other functions of the client and the server. In addition, after determining that an identity of the client is trusted, the server directly returns access data requested by the client without further confirming access permission of the client, e.g., fine-grained authentication cannot be implemented, which may also lead to a privacy leakage risk.

Based on this, an implementation of the present specification provides an authentication method. When a client accesses a server, an authentication function is implemented by using aspect programs pre-injected at predetermined pointcuts of the client and the server, so that the authentication function is decoupled from other functions of the client and the server, thereby avoiding interference to the other functions. In addition, access permission of the client is determined through authentication, and access data is returned based on the access permission, to implement fine-grained access control.

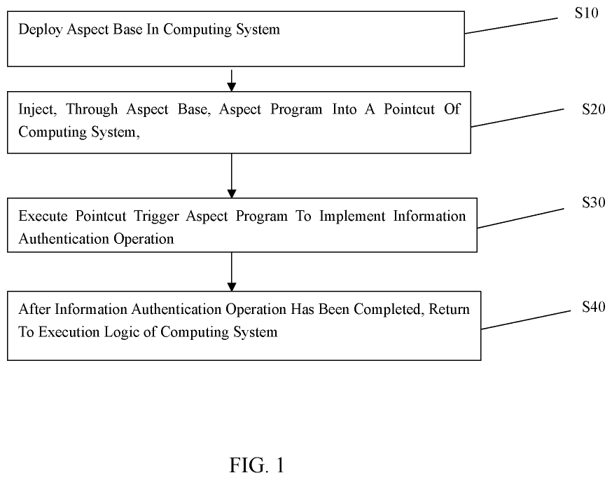

FIG. 1 show a method of operating information authentication using an aspect program. In operation S10, an aspect base is deployed in a computing system.

In operation S20, an aspect program is injected, through the aspect base, into a pointcut of the computing system. In some implementations, the aspect program is configured to implement information authentication.

In operation S30, the pointcut is executed, which triggers the aspect program to implement an information authentication process. For example, the pointcut is a function configured to receive a request to access a server, e.g., a database server, or a function to generate a request to access a server, e.g., a database server. The pointcut may be executed to receive the request or to generate the request to access the database server.

In operation S40, after the information authentication operation of the aspect program has been completed, the operation of the computing system returns to another execution logic of the computing system.

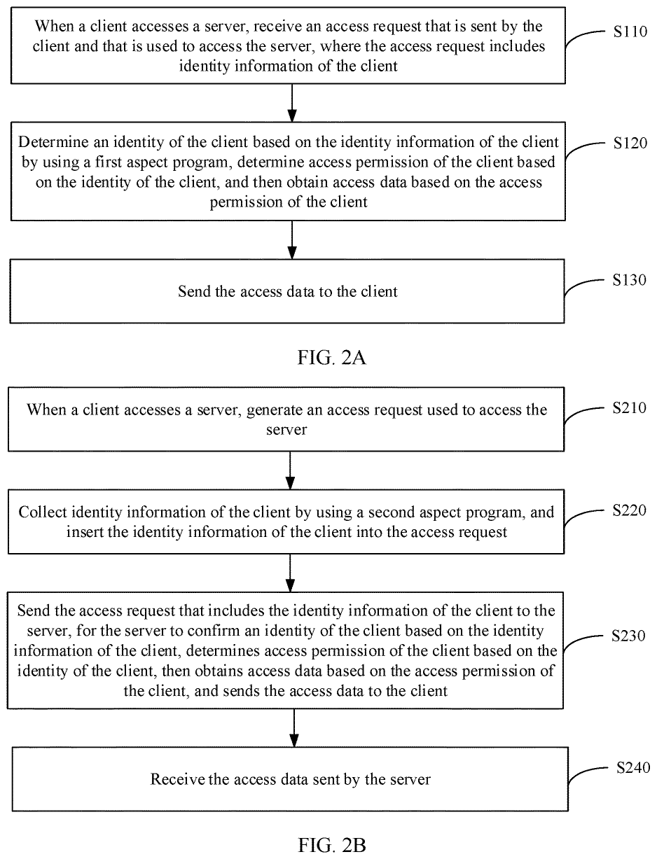

As shown in FIG. 2A, an implementation of the present specification provides an authentication method, applied to a server. A first aspect program is pre-injected at a first predetermined pointcut of the server. The authentication method includes steps S110 to S130.
S110: When a client accesses the server, receive an access request that is sent by the client and that is used to access the server, where the access request includes identity information of the client.

When the client accesses the server, the client first generates the access request, then inserts the identity information of the client into the access request, and sends the access request that includes the identity information of the client to the server. In this case, the server receives the access request that includes the identity information of the client.

In some implementations, the identity information of the client can include any suitable information for verifying an identity of the client, such as a model of a terminal device on which the client is installed, a product serial number (SN), an application version number, a terminal identity certificate, and a user phone number. After generating the access request, the client can collect the identity information of the client, and then insert the identity information of the client into the access request.
S120: Determine an identity of the client based on the identity information of the client by using the first aspect program, determine access permission of the client based on the identity of the client, and then obtain access data based on the access permission of the client.

The first aspect program is pre-injected at a first pointcut of the server. The first aspect program can be injected into the first predetermined pointcut through a first aspect base pre-deployed on the server. The injection can be static injection or dynamic injection. The first pointcut can be a predetermined pointcut or a dynamically determined pointcut. The first aspect program can execute a authentication function. When the server executes the first pointcut, the first aspect program is triggered, and the first aspect program implements an authentication function of the first aspect program. After the first aspect program completes the authentication function, the first aspect program returns to original execution logic of the server, to implement an original function of the server, which is thus separated from or decoupled from the authentication function. A location of the first pointcut can be selected in various ways, e.g., based on a requirement, which are all included in the scope of the specification. The location of the first predetermined pointcut may vary for different clients. For example, the first predetermined pointcut can be a function of receiving the access request by the server. As such, after receiving the access request by using the function of receiving the access request, the server triggers the first aspect program to implement an authentication function.

The authentication function of the first aspect program is to determine the identity of the client based on the identity information of the client, determine the access permission of the client based on the identity of the client, and then obtain the access data based on the access permission of the client.

In some implementations, determining the identity of the client can be performing identity authentication on the client, e.g., determining whether the client is an authorized client, and if the client is an authorized client, trusting the identity information of the client to determine that the identity of the client is an identity provided in the access request. In some other implementations, determining the identity of the client can also be not performing identity authentication on the client, but directly trusting the identity information included in the access request of the client to determine that the identity of the client is an identity provided in the access request.

In some implementations, that the server pre-stores standard or registered identity information of the client, and determines the identity of the client based on the identity information of the client includes: comparing the identity information of the client with the standard or registered identity information of the client in the server to determine the identity of the client.

The standard or registered identity information of the client can be registration baseline data of the client, e.g., when the client is installed on a terminal device, device and environment information registered with and reported to the server includes a model of the terminal device, a product serial number (SN), an application version number, a terminal identity certificate, and a user phone number. The comparing the identity information of the client with the standard or registered identity information of the client in the server to determine the identity of the client specifically includes a weak consistency authentication method and a strong consistency authentication method.

The weak consistency authentication method includes: comparing partial information (for example, core information, such as an identity certificate, a user phone number, and an SN) in the identity information of the client with a corresponding part (for example, a standard or registered identity certificate, a standard or registered user phone number, and a standard or registered SN) of the standard or registered identity information of the client in the server, and if the partial information is completely consistent with the corresponding part, trusting the identity information of the client to determine that the identity of the client is an identity provided in the access request; or if the partial information is not completely consistent with the corresponding part, not trusting the identity information of the client to determine that the identity of the client is invalid. In the weak consistency method, comparison needs to be performed only on the partial core information in the identity information of the client, which can reduce a calculation amount of a comparison process and also ensure certain authentication precision.

The strong consistency authentication method includes: comparing all information in the identity information of the client with the standard or registered identity information in the server, and if all the information is completely consistent with the standard or registered identity information, trusting the identity information of the client to determine that the identity of the client is an identity provided in the access request; or if all the information is not completely consistent with the standard or registered identity information, not trusting the identity information of the client to determine that the identity of the client is invalid. In the strong consistency authentication method, comparison is performed on all the information in the identity information, which has high precision, but correspondingly also has a large calculation amount.

After the identity of the client is determined, the access permission of the client can be determined, and then the access data is obtained based on the access permission. For example, an access permission configuration table is predetermined on the server, and the access permission configuration table includes an identity of each client and access permission corresponding to each client. Based on the identity of the client, the access permission corresponding to the client can be viewed in the access permission configuration table. For example, the determined identity of the client can be used to search the access permission configuration table. If an identity of a corresponding client is identified, access permission corresponding to the client is obtained, e.g., the determined access permission of the client. If an identity of a corresponding client is not identified (for example, the identity of the client does not exist in the access permission configuration table), it is determined that the client has no access permission. For a client with access permission, corresponding access data can be obtained based on the access permission of the client. For a client without access permission, the obtained access data is empty (for example, the access data cannot be obtained) or an access error prompt is provided.

In some implementations, if the identity of the client is invalid, it can be directly determined that the client has no access permission, and access data obtained by the client is empty. For an authorized client, the access permission configuration table is searched for the access permission of the client.

In some implementations, the access permission can be refined to fields, e.g., the access permission includes accessible fields of the client. The obtaining the access data based on the access permission of the client includes: determining an accessible field of the client based on the access permission of the client; and obtaining all accessible fields of the client as the access data.

In some implementations, the access permission includes an authorization interface and field information. For example, access permission of client C1 includes authorization interfaces S1 and S2, field information of S1 includes field A and field B, and field information of S2 includes all fields. It is assumed that data of S1 includes field A, field B, and field C, and data of S2 includes field D and field E. The access permission indicates that client C1 can access field A and field B of S1, and access field D and field E of S2, but cannot access field C of S1. When client C1 sends an access request for requesting the data of S1 and/or the data of S2 to the server, the server obtains field A and field B of S1 and/or field D and field E of S2 as access data and returns the access data to client C1. The access permission is refined to a fine granularity of a field, so that unauthorized access can be prevented, and privacy data leakage can be avoided, thereby implementing more secure and refined access control.

When the access permission of each client is to be changed, only the access permission configuration table in the server needs to be updated, which is very convenient.

Because the above authentication function is implemented by using the first aspect program, when modification is to be made, only the first aspect program needs to be modified, and then a modified first aspect program is delivered to a first aspect base of the server through an aspect server and is re-injected into the first predetermined pointcut through the first aspect base, so that a modified authentication function can be implemented without modifying source code of the server or affecting the source code or operations of another function of the server, which is very convenient.
S130: Send the access data to the client.

After obtaining the access data based on the access permission of the client, the first aspect program returns to original execution logic of the server, and then the original execution logic of the server sends the access data to the client, so that the client can receive data accessible to the client.

The authentication method in this implementation of the present specification is applied to the server. An authentication function is implemented by using the first aspect program pre-injected at the first predetermined pointcut of the server, so that the authentication function is decoupled from another function of the server, thereby avoiding interference to the another function. The access permission of the client is determined through authentication, and the access data is returned based on the access permission, to implement fine-grained access control.

As shown in FIG. 2B, an implementation of the present specification provides an authentication method, applied to a client. A second aspect program is pre-injected at a second pointcut of the client. The authentication method includes steps S210 to S240.
S210: When the client accesses a server, generate an access request used to access the server.

In some implementations, the access request can include a requested interface, data, and the like, so that the server returns, based on the access request, data that can be accessed by the client.
S220: Collect identity information of the client by using the second aspect program, and insert the identity information of the client into the access request.

The second aspect program is pre-injected at the second pointcut of the client. The second pointcut can be predetermined or dynamically determined. The second aspect program can be injected into the second predetermined pointcut through a second aspect base pre-deployed on the client. The injection can be static injection or dynamic injection. The second aspect program can execute a predetermined authentication function. When the client executes the second predetermined pointcut, the second aspect program is triggered, and the second aspect program implements an authentication function of the second aspect program. After the second aspect program completes the authentication function, the second aspect program returns to original execution logic of the client, to implement an original function of the client. A location of the second predetermined pointcut can be selected based on a requirement. The location of the second pointcut may vary for different clients. For example, the second pointcut can be a function of generating the access request by the client. As such, after generating the access request by using the function of generating the access request, the client triggers the second aspect program to implement an authentication function.

The authentication function of the second aspect program is to collect the identity information of the client, and insert the identity information of the client into the access request.

In some implementations, the identity information of the client can include any suitable information for verifying an identity of the client, such as a model of a terminal device on which the client is installed, a product serial number (SN), an application version number, a terminal identity certificate, and a user phone number.

In some implementations, after the identity information of the client is collected by using the second aspect program, validity check on the identity information of the client can be first performed to determine whether the identity information of the client is valid, and if the identity information of the client is valid, the identity information of the client is inserted into the access request; or if the identity information of the client is invalid, it is directly determined that the identity information of the client is invalid, and no subsequent procedure is performed.

In some implementations, after the identity information of the client is collected by using the second aspect program, preprocessing (for example, hash calculation) can be first performed on the identity information of the client, and then the preprocessed identity information is inserted into the access request.

Because the above authentication function is implemented by using the second aspect program, when modification is to be made, only the second aspect program needs to be modified, and then a modified second aspect program is delivered to a second aspect base of the client through, e.g., an aspect server and is re-injected into the second pointcut through the second aspect base, so that a modified authentication function can be implemented without modifying source code of the client or affecting the source code or operation of another function of the client, which is very convenient.
S230: Send the access request that includes the identity information of the client to the server, for the server to confirm an identity of the client based on the identity information of the client, determines access permission of the client based on the identity of the client, then obtains access data based on the access permission of the client, and sends the access data to the client.

After inserting the identity information of the client into the access request, the second aspect program returns to original execution logic of the client. The original execution logic of the client sends the access request that includes the identity information of the client to the server, for the server to determine the identity of the client based on the identity information of the client, determines the access permission based on the identity of the client, then obtains the access data based on the access permission, and sends the access data to the client. For a method in which the server determines the identity of the client based on the identity information of the client, determines the access permission based on the identity of the client, and then obtains the access data based on the access permission, reference can be made to the previous implementation. Details are omitted herein for simplicity.
S240: Receive the access data sent by the server.

The access data sent by the server is access data obtained after the server performs authentication on the client, to avoid privacy leakage caused by unauthorized access of the client.

In some implementations, the access data includes an accessible field. The server obtains the accessible field of the client based on field-based access permission, to implement fine-grained authentication and access control of the field, thereby implementing more secure and refined access control.

The authentication method provided in this implementation of the present specification is applied to the client. An authentication function is implemented by using the second aspect program pre-injected at the second predetermined pointcut of the client, so that the authentication function is decoupled from another function of the client, thereby avoiding interference to the another function.

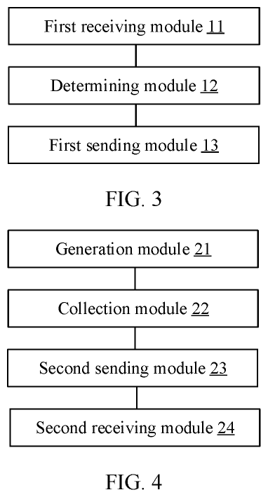

As shown in FIG. 3, an implementation of the present specification provides an authentication apparatus, applied to a server. A first aspect program is pre-injected at a first predetermined pointcut of the server. The authentication apparatus includes a first receiving module 11, a determining module 12, and a first sending module 13.

The first receiving module 11 is configured to: in response to a client accessing the server, receive an access request that is sent by the client and that is used to access the server, where the access request includes identity information of the client.

When the client accesses the server, the client first generates the access request, then inserts the identity information of the client into the access request, and sends the access request that includes the identity information of the client to the server. In this case, the server receives the access request that includes the identity information of the client.

In some implementations, the identity information of the client can include any suitable information for verifying an identity of the client, such as a model of a terminal device on which the client is installed, a product serial number (SN), an application version number, a terminal identity certificate, and a user phone number. After generating the access request, the client can collect the identity information of the client, and then insert the identity information of the client into the access request.

The determining module 12 is configured to: determine an identity of the client based on the identity information of the client by using the first aspect program, determine access permission of the client based on the identity of the client, and then obtain access data based on the access permission of the client.

The first aspect program is pre-injected at the first predetermined pointcut of the server. The first aspect program can be injected into the first predetermined pointcut through a first aspect base pre-deployed on the server. The injection can be static injection or dynamic injection.

In some implementations, determining the identity of the client can be performing identity authentication on the client, e.g., determining whether the client is an authorized client, and if the client is an authorized client, trusting the identity information of the client to determine that the identity of the client is an identity provided in the access request. In some other implementations, determining the identity of the client can also be not performing identity authentication on the client, but directly trusting the identity information included in the access request of the client to determine that the identity of the client is an identity provided in the access request.

In some implementations, that the server pre-stores standard or registered identity information of the client, and determines the identity of the client based on the identity information of the client includes: comparing the identity information of the client with the standard or registered identity information of the client in the server to determine the identity of the client.

The standard or registered identity information of the client can be registration baseline data of the client, e.g., when the client is installed on a terminal device, device and environment information registered with and reported to the server includes a model of the terminal device, a product serial number (SN), an application version number, a terminal identity certificate, and a user phone number. The comparing the identity information of the client with the standard or registered identity information of the client in the server to determine the identity of the client specifically includes a weak consistency authentication method and a strong consistency authentication method. In the weak consistency authentication method, partial information in the identity information of the client is compared with a corresponding part of the standard or registered identity information, which has a small calculation amount, and can also ensure certain precision. In the strong consistency authentication method, all information in the identity information of the client is compared with all information in the standard or registered identity information, which has high precision, but correspondingly also has a large calculation amount.

An access permission configuration table is predetermined on the server, and the access permission configuration table includes an identity of each client and access permission corresponding to each client. Based on the identity of the client, the access permission corresponding to the client can be viewed in the access permission configuration table.

In some implementations, if the identity of the client is invalid, it can be directly determined that the client has no access permission, and access data obtained by the client is empty. For an authorized client, the access permission configuration table is searched for the access permission of the client.

In some implementations, the access permission can be refined to fields, e.g., the access permission includes accessible fields of the client. The obtaining the access data based on the access permission of the client includes: determining an accessible field of the client based on the access permission of the client; and obtaining all accessible fields of the client as the access data.

The access permission is refined to a fine granularity of a field, so that unauthorized access can be prevented, and privacy data leakage can be avoided, thereby implementing more secure and refined access control.

When the access permission of each client needs to be changed, only the access permission configuration table in the server needs to be updated, which is very convenient.

Because the above authentication function is implemented by using the first aspect program, when modification is needed, only the first aspect program needs to be modified, and then a modified first aspect program is delivered to a first aspect base of the server through an aspect server and is re-injected into the first predetermined pointcut through the first aspect base, so that a modified authentication function can be implemented without modifying source code of the server or affecting another function of the server, which is very convenient.

The first sending module 13 is configured to send the access data to the client.

The authentication apparatus in this implementation of the present specification is used in the server. The determining module 12 implements an authentication function by using the first aspect program pre-injected at the first predetermined pointcut of the server, so that the authentication function is decoupled from another function of the server, thereby avoiding interference to the another function. The determining module 12 determines the access permission of the client through authentication, and returns the access data based on the access permission, to implement fine-grained access control.

As shown in FIG. 4, an implementation of the present specification provides an authentication apparatus, applied to a client. A second aspect program is pre-injected at a second predetermined pointcut of the client, and the authentication apparatus includes a generation module 21, a collection module 22, a second sending module 23, and a second receiving module 24.

The generation module 21 is configured to: in response to the client accessing a server, generate an access request used to access the server.

The collection module 22 is configured to: collect identity information of a client by using the second aspect program, and insert the identity information of the client into the access request.

The second aspect program is pre-injected at the second predetermined pointcut of the server. The second aspect program can be injected into the second predetermined pointcut through a second aspect base pre-deployed on the server. The injection can be static injection or dynamic injection.

In some implementations, the identity information of the client can include any suitable information for verifying an identity of the client, such as a model of a terminal device on which the client is installed, a product serial number (SN), an application version number, a terminal identity certificate, and a user phone number.

In some implementations, after the identity information of the client is collected by using the second aspect program, validity check on the identity information of the client can be first performed to determine whether the identity information of the client is valid, and if the identity information of the client is valid, the identity information of the client is inserted into the access request; or if the identity information of the client is invalid, it is directly determined that the identity information of the client is invalid, and no subsequent procedure is performed.

In some implementations, after the identity information of the client is collected by using the second aspect program, preprocessing (for example, hash calculation) can be first performed on the identity information of the client, and then preprocessed identity information is inserted into the access request.

Because the above authentication function is implemented by using the second aspect program, when modification is needed, only the second aspect program needs to be modified, and then a modified second aspect program is delivered to a second aspect base of the client through an aspect server and is re-injected into the second pointcut through the second aspect base, so that a modified authentication function can be implemented without modifying source code of the client or affecting another function of the client, which is very convenient.

The second sending module 23 is configured to send the access request that includes the identity information of the client to the server, for the server to confirm an identity of the client based on the identity information of the client, determines access permission of the client based on the identity of the client, then obtains access data based on the access permission of the client, and sends the access data to the client.

The second receiving module 24 is configured to receive the access data sent by the server.

The access data sent by the server is access data obtained after the server performs authentication on the client, to avoid privacy leakage caused by unauthorized access of the client.

In some implementations, the access data includes an accessible field. The server obtains the accessible field of the client based on field-based access permission, to implement fine-grained authentication and access control of the field, thereby implementing more secure and refined access control.

The authentication apparatus in this implementation of the present specification is used in the client. The collection module 22 implements an authentication function by using the second aspect program pre-injected at the second predetermined pointcut of the client, so that the authentication function is decoupled from another function of the client, thereby avoiding interference to the another function.

An implementation of the present specification provides a readable storage medium on which a computer program is stored. When the computer program is executed in a computer, the computer is caused to perform the steps of the authentication method in the above implementation of the present specification.

An implementation of the present specification provides a computing device that includes a storage and a processor. The storage stores executable code, and when the processor executes the executable code, the processor performs the steps of the authentication method in the above implementation of the present specification.

The system, apparatus, module, or unit described in the above implementations can be specifically implemented by a computer chip or an entity, or can be implemented by a product that has a function. A typical implementation device is a computer. For example, the computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the above apparatus is described by dividing functions into various units. Certainly, when the present specification is implemented, a function of each unit can be implemented in one or more pieces of software and/or hardware.

A person skilled in the art should understand that the implementations of the present specification can be provided as methods, systems, or computer program products. Therefore, the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification is described with reference to the flowcharts and/or block diagrams of the methods, the devices (systems), and the computer program products based on the implementations of the present specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

Alternatively, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, the computer includes one or more processors (CPUs), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The memory may include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. As described in the present specification, the computer-readable medium does not include computer-readable transitory media such as a modulated data signal and a carrier.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product, or device that includes the element.

The present specification can be described in the general context of computer-executable instructions executed by a computer, for example, a program module. Generally, the program module includes a routine, a program, an object, a component, a data structure, etc. executing a specific task or implementing a specific abstract data type. The present specification can alternatively be practiced in distributed computing environments in which tasks are performed by remote processing devices that are connected through a communication network. In the distributed computing environments, the program module can be located in local and remote computer storage media including storage devices.

The implementations in the present specification are described in a progressive manner. For same or similar parts in the implementations, reference can be made to each other. Each implementation focuses on a difference from other implementations. Particularly, the system implementations are basically similar to the method implementations, and therefore are described briefly. For related parts, references can be made to some descriptions of the method implementations.

The above implementations of the present specification are not intended to limit the scope of the present specification, and the above implementations of the present specification can further make various changes. For example, all simple, equivalent changes, and modifications made according to the claims and the content of the specification of the present application fall within the protection scope of the claims of the present application. All those that are not described in detail in the present specification are conventional technical content.

The various embodiments described above can be combined to provide further embodiments. All of the U.S. patents, U.S. patent application publications, U.S. patent applications, foreign patents, foreign patent applications listed in the Application Data Sheet are incorporated herein by reference, in their entirety. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
deploying an aspect base in a computing system;
injecting, through the aspect base, an aspect program into a pointcut of the computing system, the aspect program configured to implement information authentication;
executing the pointcut to trigger the aspect program to implement an information authentication operation; and
after the information authentication operation has been completed, returning to an execution logic of the computing system.

2. The method according to claim 1, wherein pointcut is a function unit of the computing system configured to receive an access request related to the information authentication.

3. The method according to claim 1, wherein the pointcut is a function unit of the computing system configured to generate an access request related to the information authentication.

4. The method according to claim 1, wherein the computing system is a server, the method further comprising:
receiving an access request from a client for accessing the server, the access request including identity information of the client;
determining an identity of the client based on the identity information of the client by using the aspect program;
determining access permission of the client based on the identity of the client;
obtaining access data based on the access permission of the client; and
sending the access data to the client.

5. The method according to claim 4, wherein the determining the identity of the client based on the identity information of the client includes:
comparing the identity information of the client with pre-stored identity information to determine the identity of the client.

6. The method according to claim 4, wherein the determining the access permission of the client based on the identity of the client includes:
searching an access permission configuration table for the access permission of the client based on the identity of the client.

7. The method according to claim 1, wherein the obtaining the access data based on the access permission of the client includes:
determining an accessible field of the client based on the access permission of the client; and
obtaining all accessible field of the client as the access data.

8. The method according to claim 1, wherein the computing system is a client device, the method further comprising:
generating an access request for accessing a server;
collecting identity information of a client by using the aspect program;
inserting the identity information of the client into an access request;
sending the access request that includes the identity information of the client to the server, for the server to authenticate the identity of the client; and
receiving access data from the server.

9. A computing system, comprising one or more storage units and one or more processors, the one or more storage units, individually or collectively, storing executable codes, the executable codes, when executed by the one or more processors, enabling the one or more processors to, individually or collectively, implement acts including:
deploying an aspect base in the computing system;
injecting, through the aspect base, an aspect program into a pointcut of the computing system, the aspect program configured to implement information authentication;
executing the pointcut to trigger the aspect program to implement an information authentication operation; and
after the information authentication operation has been completed, returning to an execution logic of the computing system.

10. The computing system according to claim 9, wherein pointcut is a function unit of the computing system configured to receive an access request related to the information authentication.

11. The computing system according to claim 9, wherein the pointcut is a function unit of the computing system configured to generate an access request related to the information authentication.

12. The computing system according to claim 9, wherein the computing system is a server, and the acts further include:
receiving an access request from a client for accessing the server, the access request including identity information of the client;
determining an identity of the client based on the identity information of the client by using the aspect program;
determining access permission of the client based on the identity of the client;
obtaining access data based on the access permission of the client; and
sending the access data to the client.

13. The computing system according to claim 12, wherein the determining the identity of the client based on the identity information of the client includes:
comparing the identity information of the client with pre-stored identity information to determine the identity of the client.

14. The computing system according to claim 12, wherein the determining the access permission of the client based on the identity of the client includes:
searching an access permission configuration table for the access permission of the client based on the identity of the client.

15. The computing system according to claim 9, wherein the obtaining the access data based on the access permission of the client includes:
determining an accessible field of the client based on the access permission of the client; and
obtaining all accessible field of the client as the access data.

16. The computing system according to claim 9, wherein the computing system is a client device, and the acts further include:
generating an access request for accessing a server;
collecting identity information of a client by using the aspect program;
inserting the identity information of the client into an access request;
sending the access request that includes the identity information of the client to the server, for the server to authenticate the identity of the client; and
receiving access data from the server.

17. A readable storage medium having computer executable instructions stored thereon, the computer executable instructions, when executed by one or more processors, enabling the one or more processors to, individually or collectively, implement acts including:
deploying an aspect base in a computing system;
injecting, through the aspect base, an aspect program into a pointcut of the computing system, the aspect program configured to implement information authentication;
executing the pointcut to trigger the aspect program to implement an information authentication operation; and
after the information authentication operation has been completed, returning to an execution logic of the computing system.

18. The storage medium according to claim 17, wherein pointcut is a function unit of the computing system configured to receive or generate an access request related to the information authentication.

19. The storage medium according to claim 17, wherein the computing system is a server, and the acts further include:
receiving an access request from a client for accessing the server, the access request including identity information of the client;
determining an identity of the client based on the identity information of the client by using the aspect program;
determining access permission of the client based on the identity of the client;
obtaining access data based on the access permission of the client; and
sending the access data to the client.

20. The storage medium according to claim 17, wherein the computing system is a client device, and the acts further include:
generating an access request for accessing a server;
collecting identity information of a client by using the aspect program;
inserting the identity information of the client into an access request;
sending the access request that includes the identity information of the client to the server, for the server to authenticate the identity of the client; and
receiving access data from the server.
